(19) United States
(12) Patent Application Publication
(10) Pub. No.: US 2002/0062305 A1
(43) Pub. Date: May 23, 2002

(54) Database management systems

(75) Inventor: Adam Peter Gawne-Cain, Oxford (GB)

Correspondence Address: YOUNG & THOMPSON, 745 SOUTH 23RD STREET 2ND FLOOR, ARLINGTON, VA, 22202

(73) Assignee: Gawne-Cain Research Limited

(21) Appl. No.: 09/987,592

(22) Filed: Nov. 15, 2001

(30) Foreign Application Priority Data
Nov. 21, 2000 (GB) 0028311.9

(51) Int. Cl. G06F 7/00

(52) U.S. Cl. 707/1

(57) ABSTRACT

A database management system is adapted to hold permanent records of the states of a database both before and after database-modifying transactions so as to allow all previous states of the database to be directly accessed, without requiring storage of large amounts of redundant information. To this end the system relates parent data items (such as America, Spain; S*) in the record of each database state to dependent data items (such as Africa, Canada, France; France, Turkey) in the record of the same database state. Additionally the system relates a root data item (such as England; E*) in the record of each database state to the other data items in that record. Such relationships allow the state of the database after a database-modifying transaction to be determined by relating the root data item (E*) corresponding to that database state to both data items (S*, Turkey) in the record of that database state and data items (America, Africa, Canada, France) in the record of the state of the database before the data-modifying transaction.

### BACKGROUND OF THE INVENTION

This invention relates to a database management system, and is concerned more particularly with such a database management system for maintaining chunks of data indicative of the states of the database both before and after a transaction modifying the state of the database.

Generally, the method used by a conventional database management system (DBMS) to maintain a computer database over time involves adding, modifying and deleting data records. Since the data records are modified and deleted, the previous states of a mature database cannot be directly revealed.

In certain known systems the accessing of old versions of relational databases is possible by recording all transaction instructions in accompanying log files, along with copies of the database file at certain checkpoints. However, this method is unsatisfactory, since the log files must be laboriously replayed from the previous checkpoint copy, and the checkpoint copies and log files take up a lot of space, since they contain so much logically redundant data.

It is an object of the present invention to provide a structure for a DBMS to enable a database to be maintained over time in such a manner as to allow a large number of previous states of the database to be directly revealed in a particularly straightforward manner.

### SUMMARY OF THE INVENTION

According to the present invention there is provided a database management system for maintaining chunks of data indicative of the states of a database comprising a plurality of data items, both before and after a transaction modifying the state of the database, the system comprising:

(a) memory means for holding data chunks providing permanent records of (i) the state of the database before the database-modifying transaction and (ii) the state of the database after the database-modifying transaction;

(b) relation determination means for relating at least one parent data item in the data chunk indicative of each database state to at least one dependent data item in the same data chunk;

(c) root determination means for determining the position of a root data item in the data chunk indicativeof each database state to which other data items in that data chunk are related; and

(d) state determination means for determining the state of the database after the database-modifying transaction by relating the root data item corresponding to that database state to both at least one data item in the data chunk corresponding to that database state and at least one data item in the data chunk corresponding to the state of the database before the data-modifying transaction.

Such a DBMS enables a computer database to be maintained over time in such a manner as to allow all previous states of the database to be directly accessed and without requiring the storage of large amounts of redundant data.

The structure of such a DBMS may be likened, by analogy, to the way in which many types of tree grow by laying down a new ring of wood each year. This structure means that all previous states of a mature tree can be directly revealed by stripping away the tree's outer rings. In an analogous way, the present invention relates to a DBMS by which a computer database can be flexibly maintained over time, preferably by exclusively adding data items to the database, and preferably without requiring any existing data items to be modified or deleted.

Preferably, during each database-modifying transaction, a chunk of new data items are appended to the end of the growing database file. Previous data items in previous chunks in the file will not need to be modified. In this way, all previous states of the database can be directly revealed by the DBMS by only considering a certain number of the initial chunks, whilst ignoring the remainder of the appended chunks. For example, if the database file consists of seven chunks, corresponding to seven transactions, then the state of the database after the third transaction can be revealed by the DBMS examining the first three chunks, and temporarily ignoring the last four chunks.

Preferably, the records within the chunks are structured according to the following principles:

Chunks of data items are appended to the database file as transactions are made

Chunks are never edited once they have been appended to the file

Chunks are on average small compared to the total size of the previous database file.

Chunks refer to data items in previous chunks where those data items have not been logically deleted or modified by the transaction.

Chunks mask out data items in previous chunks where those data items have been deleted or modified by the transaction.

Chunks do not reference data items in subsequent chunks.

These principles are preferably achieved in the following manner:

Each data item has a position in a chunk in the file.

Data items may be parent data items.

Each parent data item contains data indicating the position of its dependent data items.

Each transaction chunk contains the position of a root data item.

The DBMS can traverse a network of data items by tracking dependent data items from a root data item, and then recursively tracking more dependent data items from the data items already visited.

As the DBMS traverses this network of data items, it can suitably include means for recording the position of the parent data item of each visited dependent data item.

Thus dependent data items in chunks in the database file do not store the positions of their parent data items.

Depending on the root data item used to initiate a traversal, the DBMS may reveal a different network of data items.

Generally, in computer science, a database can be said to have a “physical” state, and a “logical” state. The physical state is the arrangement of data stored in a suitable computer data storage device, such as a magnetic disk or a CD-ROM. A logical state is a conceptual view of the information embodied by these data. In general, a DBMS is a computer program that can manipulate the physical state while presenting a possibly different logical state to other computer programs.

The DBMS in accordance with the present invention can present a modified logical database state, wherein data items have been added, edited or deleted, by adding data items to the physical state of the database, without the need to edit or delete existing data items in the physical state.

Preferably, during a database-modifying transaction, the DBMS will prepare a chunk of data items to be appended to the database file in the following manner:

New dependent data items can be inserted into the new chunk.

Logically edited data items in previous chunks must be copied.

All undeleted ancestors of logically edited or deleted data items must also be copied.

Existing, unedited dependent data items of edited parent data items do not need to be copied. The new parent data item copy can reuse the positional data for the unedited dependent data items in the previous chunks.

The chunk will contain data indicating the position of a new root data item.

The chunk will contain data indicating the position of a previous chunk.

Thus each database transaction is embodied in a chunk of data, and the DBMS can directly reveal the entire state of the database as it was immediately after a transaction of interest by traversing a network of data items starting from a root data item indicated in the corresponding transaction's chunk of data. In this way the DBMS can directly reveal a snapshot of the database as it was at any moment in between transactions in the database's history.

In one embodiment of the invention the data values which occur frequently, or are likely to occur frequently in the logical database state, may be stored in data items in a part of the network of data items, in such a way that they can be reused as dependent data items of many other data items. For example, textual values such as “London” may occur frequently in a database of UK addresses.

Furthermore, in an embodiment of the invention, the network of data items may be in the form of a traditional network database. Generally a network database allows data records to be linked together in ways appropriate for application programs. Whilst traditional network databases conventionally do not enable old versions of the database to be directly revealed, it is possible to ensure that the DBMS of this embodiment enables all old versions of the network database to be revealed directly.

For example the network of data items may constitute a traditional relational database incorporating tables, views, columns, rows, fields, etc. The DBMS may contain an interpreter for standard query languages (SQL) which would enable users to access and modify a fully functional relational view of the database. In addition users would be able to directly access a relational view of the database at all moments in between transactions in the database's history.

Furthermore the network of data items may constitute an object database. Generally an object database contains objects which consist of encapsulated data and programmatic behaviour. In this case, the network would contain data items corresponding to object classes and object instances. Logical references between the objects would be modelled by the data items corresponding to the referring objects containing data indicating the positions of the data items corresponding to the referred objects.

In another embodiment of the invention, the network of data items may constitute a virtual disk drive (VDD), with the extra functionality of being able to directly access the logical state of the VDD at any time in its past. Generally a virtual disk driver is a computer software interface which allows other computer programs to treat the software implementation of that interface as if it were a computer disk, so that such an interface typically supports functions such as reading, writing and modifying data at random positions within a certain range of valid positions. Preferably certain data items in the network of data items would correspond to ranges of positions within the virtual disk (e.g. disk sectors). These data items would contain the data that was logically stored in the corresponding region of the virtual disk. If a computer application wished to modify the contents of a region in the VDD, then the DBMS would prepare a new transaction chunk corresponding to that logical disk modification. The DMBS would prepare the chunk by locating the data item or data items corresponding to the region in the VDD, and creating new versions of those data items. Preferably the DBMS would sometimes split or merge the logical ranges corresponding to physical records to increase the efficiency of the physical data in representing the corresponding logical data. Thus the amount of virtual disk embodied in different records may vary. Preferably the parent/dependent hierarchy of data items in the network of data items would relate to the locations of the corresponding regions and sub-regions on the virtual disk.

In a further embodiment of the invention a version control system (VCS) may be incorporated in the DBMS. Such a VCS would allow versions of the database be arranged in series to show how the database developed. The VCS can also contain branch points at which alternative versions of the logical state of the database are allowed to develop in parallel.

Preferably each new chunk of data contains data indicating the position of a previous chunk of data. This previous chunk of data may or may not be the chunk immediately preceding the new chunk in the file. The previous chunk may be an even earlier chunk. In this way, the VCS can arrange the chunks into a logical tree of versions. Preferably each new chunk will also contain metadata such as the time it was created, the name of the user who made the change, the motivation of the user making the change, and the project, job or business associated with the change.

Certain data items in the network of data items, called version data items, may, along with their descendant data items, embody a particular version of a logical database. The version data items may themselves be dependent data items of version control data items. Preferably the VCS can navigate the network of data items from a root data item, via the version control data items, to the version data items, and thence to the logical database data items.

Generally, in a multi-user, transactional database, several users (who may be humans or other computer programs) can access the database simultaneously. If a user wishes to modify the database, the user begins a transaction, makes the necessary modifications, and then attempts to commit the transaction. If several users wish to modify the database simultaneously, then one or more of the users may have their modification request rejected by the DMBS (either at the begin stage, or the commit stage).

In a development of the invention a multi-user DBMS is provided which avoids ever having to reject a modification due to several users requesting a modification simultaneously, by incorporating the VCS functionality related earlier into the begin+commit transaction logic. Preferably, at the instant when a user begins a transaction, the DBMS can associate the chunk associated with that user's logical view of the database at that instant with the transaction. Then, when the user commits their transaction, the DBMS can append a new chunk which, when viewed via the VCS, logically follows on from the chunk associated with the transaction. If several users have transactions open simultaneously, and they subsequently commit their transactions, then the DBMS may need to store the new versions in different branches. These branches can be reconciled later, possibly using application specific algorithms.

Generally application programs often provide users with undo/redo commands permitting users to make changes to the database (e.g. a word-processing file) confident that they can undo any changes made, and then redo them if they change their mind. This frees users from some of the undesirable consequences of making mistakes.

In a further development of the invention VCS functionality is incorporated into the DBMS to support the data management of an application that provides the user with an undo/redo mechanism. Preferably, as the user makes changes, the DBMS adds transactional chunks to the database. If the user uses the undo command, the VCS within the DBMS preferably reverts to an earlier version of the database, so the user will see the modification being undone. Preferably, if the user then makes a different change, the DMBS appends another transactional chunk, and the VCS creates a new branch for that change. In this way all the database states which the user causes, and the order of those states, are recorded. Thus the DBMS automatically collects the raw data required to analyse the behaviour and effectiveness of the user, and the mistakes made by the user. This raw data can be used to monitor the users' performance, help train users, and improve the user interface of the application software.

In an application of the invention, the DBMS may use append-only unmodifiable media to physically store the database, and yet present a logical view of the database which can be modified. For example, some types of compact disk can have data appended, but cannot modify data which has already been written. These types of append-only media are sometimes referred to as write-once-read-many (WORM) devices.

### BRIEF DESCRIPTION OF THE DRAWINGS

In order that the invention may be more fully understood, reference will now be made, by way of example, to the accompanying drawings, in which:

FIG. 1 shows schematically the physical structure of chunks in the database file of a DBMS in accordance with the invention;

FIG. 2 shows schematically the logical and physical states of such a database during a transaction;

FIG. 3 shows schematically how a DBMS in accordance with the invention can logically structure records to represent a general relational database;

FIG. 4 shows schematically how a VCS can arrange chunks in a database file of a DBMS in accordance with the invention; and

FIG. 5 shows schematically how a VCS can logically structure records to represent a general relational database with version control of a DBMS in accordance with the invention.

### DETAILED DESCRIPTION OF THE DRAWINGS

It should be understood that the figures are intended to show only the structure of simple exemplary DBMS's in accordance with the invention by way of illustration of the principles underlying such a system, and that actual systems which are likely to be produced in accordance with the invention will incorporate additional levels of structural complexity including additional features which would be well understood to those skilled in the art.

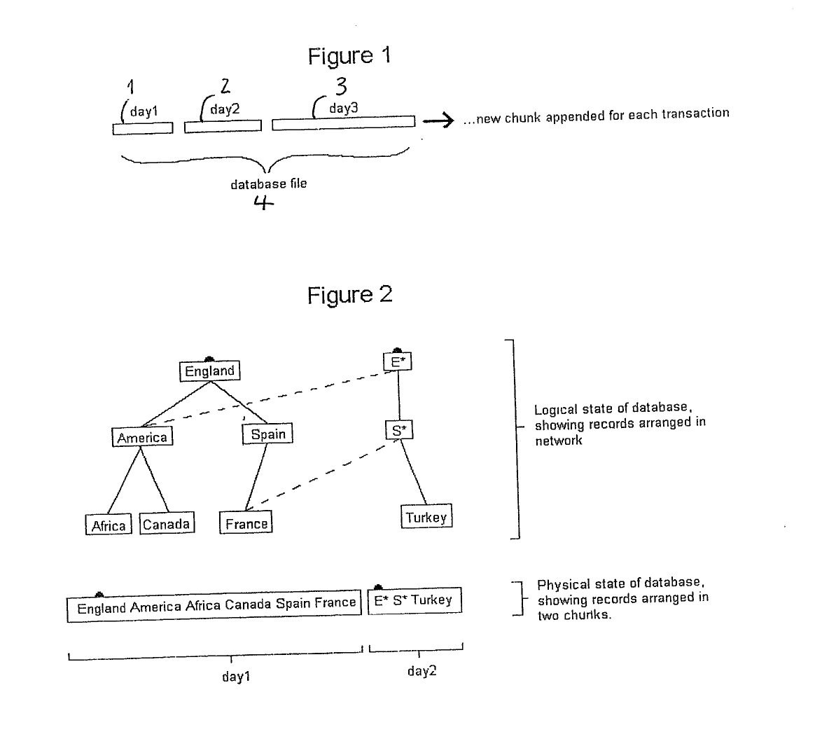

FIG. 1 shows how the basic structure of such a DBMS involving formatting a database file as a series of chunks where a new transaction each day causes a new chunk to be appended to the file. The boxes marked day1, day2 and day3 show the chunks which are appended onto the file each day.

FIG. 2 is an exemplary embodiment showing how the logical and physical states of a database are related during a database-modifying transaction, in the case where the database in question is a simple network database. The top part of the figure shows the logical states, and the bottom part of the figure shows the corresponding physical states. The lefthand side of the figure shows the state of the database on day 1 before the transaction, and the righthand side of the figure shows the state of the database on day 2 after the transaction. Each transaction chunk preferably contains the position of a root data item. The root data item for each chunk in each physical state diagram is indicated by a black semicircle.

Before the database-modifying transaction, the database contains six data items containing the names of six regions of the world: England, America, Africa, Canada, Spain and France. In the logical state the data items are presented in a binary tree. In this example, the binary tree is sorted, which means that every parent data item is alphabetically later than all of its lefthand side descendants, and alphabetically earlier than all of its righthand side descendants. In the physical state, the data items are stored inside a single chunk. In the physical state, the parent data items (England, America and Spain) will also contain data indicating the position of the dependent data items (America, Span, Africa, Canada and France).

In this example, a user wishes to add a new data item “Turkey” into the database. Accordingly the new data item “Turkey” is inserted into the new chunk. Since, in this example, the DBMS wishes the binary tree to remain sorted, the new Turkey data item will be inserted into the logical state as the righthand dependent data item of a Spain data item. This means that the old Spain data item must be copied, and the copied data item is labelled S* in the diagram. Similarly the old England data item is copied as E*. Thus the new chunk will physically contain three data items: E*, S* and Turkey. The new E* data item will have America and S* as its dependent data items. The new S* data item will have France and Turkey as its dependent data items. The diagram shows how the two different logical states of the network database (i.e. before and after the transaction) can be directly revealed by traversing the network from the root data item of one of the two chunks.

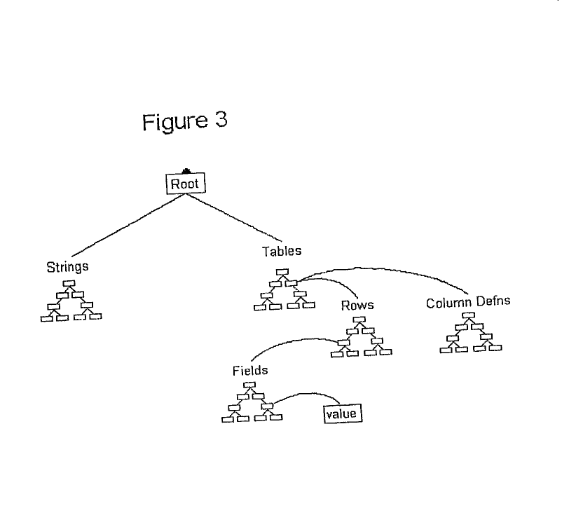

FIG. 3 is a representation of a general purpose relational database as a network of data items for use with a DBMS in accordance with the invention. In this example, there are different types of record, corresponding to traditional elements of relational database, such as strings, tables, rows, fields, column definitions and data values. Each table in the relational database has a corresponding table record. The table records are arranged into a sorted binary tree. In this exemplary scheme, each table record has up to two dependent table records. Each table record also contains data indicating the name of the table within the relational database. This binary tree structure of table records does not have an analogous structure in classical relational database theory. In classical relational database theory, tables are considered to be more independent, with relationships between tables being inferred as-and-when required with join operations. The binary tree structure is used here to help the DBMS locate a table from its name.

Each table record also has a dependent record which forms the local root of a sub-network of row records. Each row record contains data which appears in a row in the relational database table corresponding to the table record in question. The diagram only shows the row sub-network for one of the table records, although it should be understood that each table record preferably contains its own row sub-network. Similarly the diagram shows how each table record contains its own column definition sub-network, and each row record contains its own field sub-network, and each field record contains data indicating the field value.

In the example of FIG. 3, there is a separate sub-network for strings. This sub-network contains canonical records for commonly occurring text values. Thus, if many relational database fields have the value “London”, then all the corresponding field records can store the position of a single, canonical string record representing “London”.

Classically, a relational database is presented as a collection of tables. This tabular structure can be transformed into a network structure. There may be several ways to achieve this transformation, and one possible way is shown in FIG. 3. Whatever transformation is used, once a relational database or network database or object database or virtual disk drive or any other form of applicable database is converted into a network structure, the principles underlying present invention enable historical tracking and version control functions to be added.

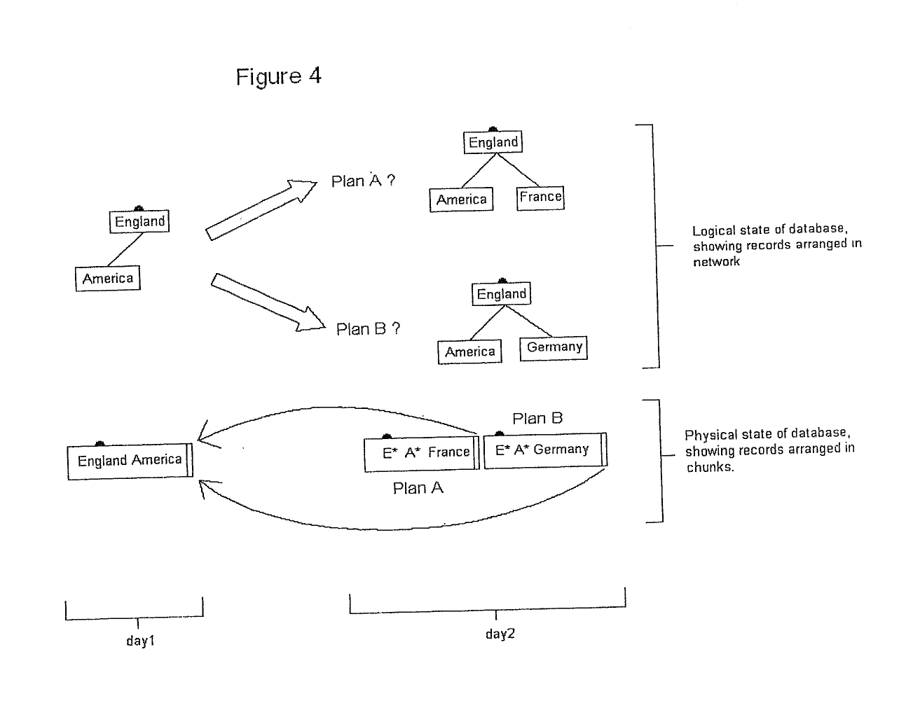

FIG. 4 shows an example of how the logical and physical states of a database are related during alternative simultaneous database-modifying transactions in a DBMS in accordance with the invention, for the case where the database is a simple network database. The top part of the figure shows the logical states, and the bottom part of the figure shows the corresponding physical states. The lefthand side of the figure shows the state of the database on day 1 before the alternative simultaneous transactions, and the righthand side of the figure shows the possible states of the database on day 2 after these transactions. Furthermore each transaction chunk preferably contains the position of a root record. The root record for each chunk in each physical state diagram is indicated by a semicircle.

In this example the database contains two records on day 1 containing the names of two regions of the world: England and America. Furthermore two different users A and B wish to make simultaneous additions to the database. User A wishes to add the record France, and user B wishes to add the record Germany. For the sake of this example, it is assumed that adding France and Germany are mutually exclusive options within any one logical database state.

The righthand side of FIG. 4 shows at the top the two alternative logical databases which would result on day 2 from these additions. The bottom righthand side of FIG. 4 shows how both additions can be physically logged in the database. This is done by adding two more chunks, corresponding to the two different transactions. Each transaction is based on the initial chunk. According to the principles underlying the present invention each chunk contains data indicating the position of a previous chunk. As the diagram shows, both of the new chunks will contain data indicating that their previous chunk is the first chunk.

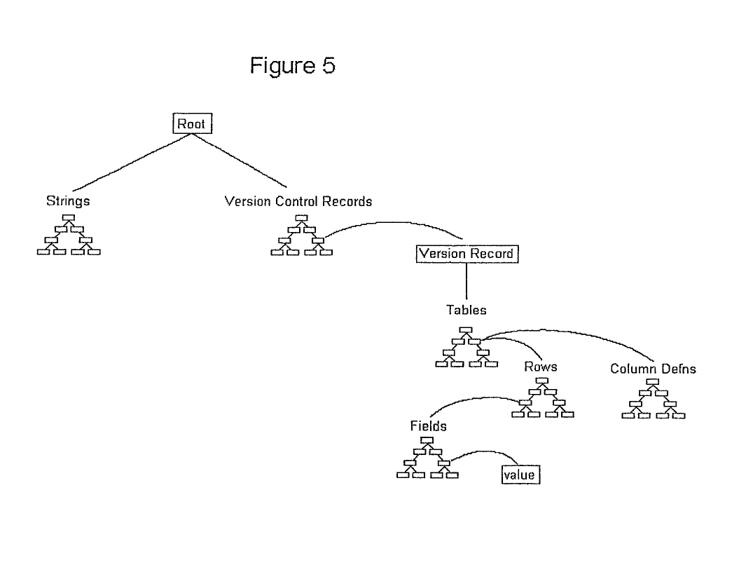

FIG. 5 is an elaboration of the relational database schema shown in FIG. 3 for use with a DBMS in accordance with the invention. In this example the network schema has new record types for version control records, and version records. These new record types allow the VCS to track historical versions of the relational database on different development branches, as well as backwards and forwards in linear development steps.

1. A database management system for maintaining chunks of data indicative of the states of a database comprising a plurality of data items, both before and after a transaction modifying the state of the database, the system comprising:
(a) memory means for holding data chunks providing permanent records of (i) the state of the database before the database-modifying transaction and (ii) the state of the database after the database-modifying transaction;
(b) relation determination means for relating at least one parent data item in the data chunk indicative of each database state to at least one dependent data item in the same data chunk;
(c) root determination means for determining the position of a root data item in the data chunk indicative of each database state to which other data items in that data chunk are related; and
(d) state determination means for determining the state of the database after the database-modifying transaction by relating the root data item corresponding to that database state to both at least one data item in the data chunk corresponding to that database state and at least one data item in the data chunk corresponding to the state of the database before the data-modifying transaction.

2. A system according to claim 1, wherein the state determination means is arranged to relate the root data item in the data chunk corresponding to the database state of the database after the database-modifying transaction to at least one dependent data item by way of at least one parent data item by use of the relation determination means associated with that parent data item.

3. A system according to claim 2, wherein the state determination means is arranged to record the position of the parent data item corresponding to each dependent data item during the tracking of data items.

4. A system according to claim 1, wherein new record compiling means is provided to compile a supplementary chunk of data indicative of the state of the database after the database-modifying transaction and is arranged to copy those data items from the previous record which have been modified by the transaction whilst not copying those data items from the previous record which have not been modified by the transaction.

5. A system according to claim 4, wherein the new record compiling means is arranged to copy dependent data items from the previous record which have been modified by the transaction, as well as parent items to which those dependent data items are related by the relation determination means.

6. A system according to claim 1, wherein presentation means is provided to present the data items in each record in a different logical structure.

7. A system according to claim 6, wherein the presentation means is adapted to present the data items in the form of a relational database.

8. A system according to claim 6, wherein the presentation means is adapted to present the data items in the form of an object database.

9. A system according to claim 6, wherein the presentation means is adapted to present the data items in the form of a virtual disk drive.

10. A system according to claim 1, wherein previous state location means is provided to relate the data chunk indicative of the state of the database after the database-modifying transaction to the position of the data chunk indicative of the state of the database before the database-modifying transaction.

11. A system according to claim 1, which incorporates a version control system (VCS) defining branch points at which alternative versions of the logical state of the database are allowed to develop in parallel.

12. A system according to claim 11, which is a multi-user system permitting several users to modify the database simultaneously to produce alternative versions of the state of the database after modification, wherein the memory means is adapted to permanently hold a record of the state of the modified database produced by each user together with an indication of the user's logical view of the database before modification.

13. A system according to claim 11, which provides the user with an undo/redo mechanism, wherein the memory means is adapted to permanently hold records of the state of the modified database produced by first and second database-modifying transactions, whereby, after a first database-modifying transaction made by the user, the state of the database before such database-modifying transaction may be determined in response to an undo command from the user, and subsequently the state of the database after a second database-modifying transaction different to the first database-modifying transaction may be determined in response to a redo command from the user, as an alternative to determination of the state of the database after the first database-modifying transaction.

14. A system according to 13, wherein analysing means is provided to analyse database-modifying transactions made by the user.

15. A system according to 13, wherein mistake identifying means is provided to identify common mistakes made by user in making database-modifying transactions.

16. A system according to claim 1, wherein each record contains metadata providing information relating to the creation of the record.

18. A programmed computer incorporating a database management system according to any preceding claim.

19. A data storage medium incorporating data recorded by a database management system according to any preceding claim.
